(19) United States
(12) Patent Application Publication
(10) Pub. No.: US 2026/0022922 A1
(43) Pub. Date: Jan. 22, 2026

(54) MINIATURE GLIDE PROJECTILE LAUNCHED FROM UNMANNED AERIAL SYSTEM

(71) Applicant: L3Harris Technologies, Inc., Melbourne, FL (US)

(72) Inventors: Zac SPEARS, New Richmond, OH (US); Eric WELLMAN, Cincinnati, OH (US); Sean TREADWAY, Mooresville, NC (US); Mike WORSHAM, Mooresville, NC (US); Anthony NELSON, Huntersville, NC (US)

(21) Appl. No.: 18/659,183

(22) Filed: May 9, 2024

(51) Int. Cl. F42B 10/64; B64D 1/04; F42B 33/00

(52) U.S. Cl. CPC F42B 10/64; B64D 1/04; F42B 33/001

(57) ABSTRACT

A projectile for use with an unmanned aerial vehicle is adaptively configured to permit the projectile payload unit to be selectively changed by personnel in the field. The projectile body may be threaded or otherwise configured to engage a correspondingly configured aft end of a payload unit. Payload units designed for different mission functions may be engaged by the projectile body so that a mission-appropriate payload can be selected and secured to the projectile body aboard ship or other location from which the unmanned aerial vehicle is to be dispatched.

### TECHNICAL FIELD

The present disclosure pertains generally to improvements in miniature weapons and other payloads launched at targets from small unmanned aerial vehicles (UAVs), and more particularly to improvements in payload flexibility for such weapons.

### BACKGROUND

Projectile delivery systems designed for launch from an unmanned aerial vehicle (UAV) are known in the prior art and may include one or more projectiles and a vehicle system (e.g., a UAV) from which the projectiles are launched. The vehicle system and its positioning are controlled from a base site such as a ship or other military installation. For example, an arrangement of this type is disclosed in U.S. Pat. No. 11,685,527 (the “Treadway et al patent”), the entire disclosure in which is incorporated herein by reference. The miniature projectile provided in such systems may be manufactured with an integrated warhead designed for a particular type of mission or function, e.g., tank penetration, anti-personnel, etc. In the system disclosed in the Treadway et al patent the warhead is permanently secured to the projectile body with multiple bolts during manufacture of the projectile. If, for any of a variety of reasons, after delivery to a customer (i.e., in the field), the projectile is needed for a mission other than that for which it was designed, that projectile cannot readily be modified for that mission. It is an object of this disclosure to provide a system and method for imparting mission flexibility to projectiles of the type described and, more specifically to provide a projectile modifiable in the field for use in a variety of different missions.

### SUMMARY

In accordance with one aspect of the principles described herein, a projectile for use with and delivery from an unmanned aerial vehicle is adaptively configured to permit the projectile warhead or other payload unit to be easily and selectively removed and replaced by personnel in the field. In one example embodiment the forward end of the projectile body is threadedly configured to be received in a correspondingly threaded aft end of a payload. Payloads designed for different missions or functions are all correspondingly threaded to engage the threading projecting from the projectile body so that a payload can be selected and secured to the projectile body aboard ship or other location from which the unmanned aerial vehicle is to be dispatched. With this arrangement it is not necessary for the entire projectile delivery module to be limited to a specific type of mission. The threaded engagement may be provided with conventional rotational and/or axial positional locking features configured to prevent inadvertent loosening of the engagement.

The intended removable engagement between payloads and the projectile body need not be limited to a threaded engagement; rather, any type of removable engagement may be used, provided that once the desired payload is attached, the engagement can withstand the stresses encountered in mission use. For example, latches, snap fits, rotational locks, etc., may be used. Thus, in accordance with another aspect, a projectile system adapted for launch from an unmanned aerial vehicle controlled from a base site, comprises a projectile body having forward and aft ends, and a first payload having an aft end configured for manually removable engagement at the base site with the forward end of the projectile body.

According to another aspect, a method is provided for replacing payloads of a projectile adapted for launch from an unmanned aerial vehicle controlled from a base site. The method, performed at the base site, comprises manually unscrewing first payload from a threaded engagement with the forward end of the projectile body, and manually screwing a second payload onto the forward end of the projectile body, and wherein the first and second payloads are configured to perform different respective mission functions.

### BRIEF DESCRIPTION OF THE DRAWINGS

By way of example, specific illustrative systems of the present disclosure will now be described with reference to the accompanying drawings in which like reference numerals in the various figures represent similar of like components.

FIG. 1 is a perspective view of a miniature projectile configured in accordance with the principles described herein.

FIG. 2 is a broken perspective view of an electronic safe and arming module located at the forward end of the projectile body of FIG. 1.

FIG. 3 is a perspective view in longitudinal section of the payload of the projectile of FIG. 1.

FIG. 4 is an exploded perspective view of the electronic safe and arming module illustrated in FIG. 2.

### DETAILED DESCRIPTION

The present systems and methods are described more fully hereinafter with reference to the accompanying drawings. It will be readily understood that the components of the systems and methods as generally described herein and illustrated in the appended drawings may be arranged and designed in a wide variety of different configurations. Thus, the following more detailed description of systems and methods, as represented in the drawings, is not intended to limit the scope of the present disclosure but is merely representative of various systems and methods. While various aspects are presented in the drawings, the drawings are not necessarily drawn to scale unless specifically indicated.

The techniques and approaches disclosed herein may be implemented in other specific forms without departing from its spirit or essential characteristics; that is, the described implementations are to be considered in all respects only as illustrative and not restrictive. The scope of inventions disclosed herein is therefore indicated by the appended claims rather than by this detailed description. All changes that come within the meaning and range of equivalency of the claims are to be embraced within their scope.

Reference throughout this specification to features, advantages, or similar language does not imply that all the features and advantages that may be realized with the disclosed apparatus, system and method should be or are in any single implementation. Rather, language referring to the features and advantages is understood to mean that a specific feature, advantage, or characteristic described in connection with an implementation is included in at least one implementation. Thus, discussions of the features and advantages, and similar language, throughout this specification may, but do not necessarily, refer to the same implementation.

Furthermore, the described features, advantages, and characteristics of the disclosed principles may be combined in any suitable manner in one or more implementations. One skilled in the relevant art will recognize, considering the description herein, that the implementations can be practiced without one or more of the specific features or advantages of a particular implementation. In other instances, additional features and advantages may be recognized in certain implementations that may not be present in all implementations.

Reference throughout this specification to “one embodiment,” “an embodiment,” or similar language means that a particular feature, structure, or characteristic described in connection with the indicated embodiment is included in at least that one embodiment, but not necessarily embodiments.

Definitions: As used herein, the following terms are understood to have the indicated meanings:
The term “UAV” means an unmanned ariel vehicle such as a drone.
The term “projectile” as used herein means a missile capable of being remotely guided after launch from a UAV.
The term “payload” as used herein means the object being carried for delivery by a projectile launched from a UAV and may be an explosive warhead, a kinetic warhead, or a container for delivering toxic materials, critical supplies, equipment, etc.
The relative terms “forward”, “aft”, “length”, “width”, and the like, as used herein are for ease of reference in the description to merely describe points of reference and are not intended to limit any particular orientation or configuration of the described subject matter.

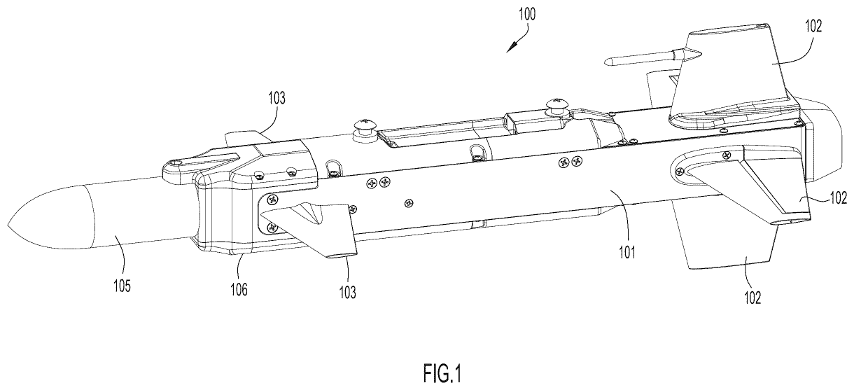

Referring more specifically to the accompanying drawings, and particularly to FIG. 1, a projectile 100 includes an elongate projectile body 101, for example of the type described and illustrated in the Treadway et al patent. The forward end of body 101 comprises an electronic safe and arming device (ESAD) 106, described in more detail below. Forward stabilization fins 103 extend transversely from the projectile body 101 from a location at or proximate ESAD module 106, while aft stabilization fins 102 extend transversely from a location proximate the aft end of the body. The projectile body may house an onboard steering system, for example of the type disclosed in the Treadway et al patent, and may include a steering mechanism operable to change an attitude, orientation, and/or direction of flight of the projectile, and a steering actuator operable to control the steering mechanism. A radiofrequency (RF) receiver may also be located on board and adapted to receive signals from a base site from which the projectile system is controlled.

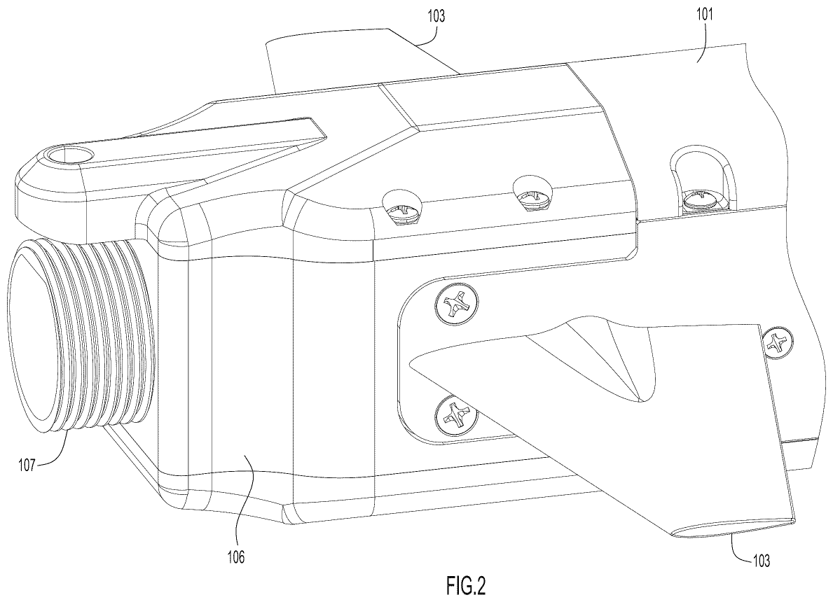

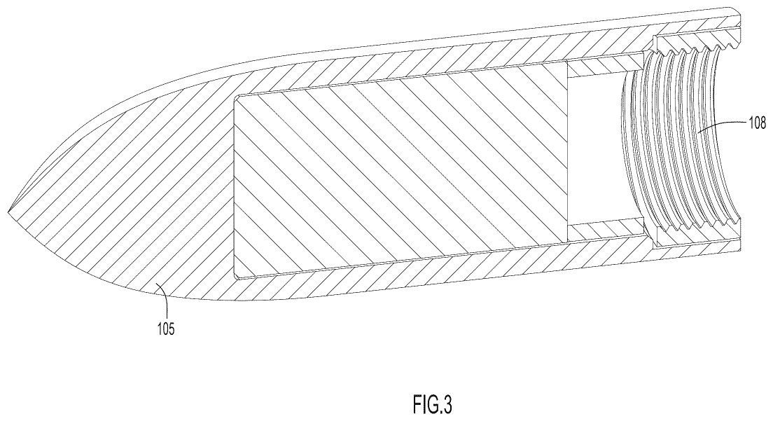

Projecting forwardly from the forward end of the ESAD module 106 is an elongate payload, for example, a warhead 105. The warhead may be of the kinetic energy or explosive type, depending on its intended mission or function. Unlike the permanently bolted connection between the warhead and projectile body disclosed in the Treadway et al patent, in accordance with the principles described herein the warhead 105 is removably engaged with body 101. As used herein, “removably engaged” or “removable engagement” means that the warhead is secured to the projectile so as to be readily replaceable by personnel who will be operating the projectile from a ship or other military installation, by hand or without the need for specialized tools or installation equipment. One such removable engagement is illustrated in FIGS. 2 and 3 wherein an externally threaded tubular connector 107 is shown projecting forwardly from the forward end of ESAD module 106. Connector 107 is configured to be axially received in and threadedly engaged with the internally threaded section 108 of the hollow aft end of warhead 105. Although it is possible within the scope of the concepts described herein to provide external threading on the warhead and internal threading in connector 107, it is preferred that the threading be provided as illustrated in the drawings.

It will be appreciated that the principles of removable engagement between the projectile body and payload as described herein are not limited to the use of threads; that is, any manually performed engagement and disengagement may be used. For example, a connector 107 and the aft interior wall section of the payload need not be threaded but, instead, one or more locking tabs may extend a short radial distance from the outer wall of an unthreaded connector 107. Such tabs may be configured to be received in and slide along respective longitudinal receiving slots defined in the unthreaded interior surface of the payload as the connector is longitudinally inserted into the warhead aft end. When the connector is fully inserted it may be rotated so that the tabs move a short angular distance within angularly extending extensions of the receiving slots until reaching an angular lock position. Other removable engagement examples may include exterior latches, snap-fits, etc.

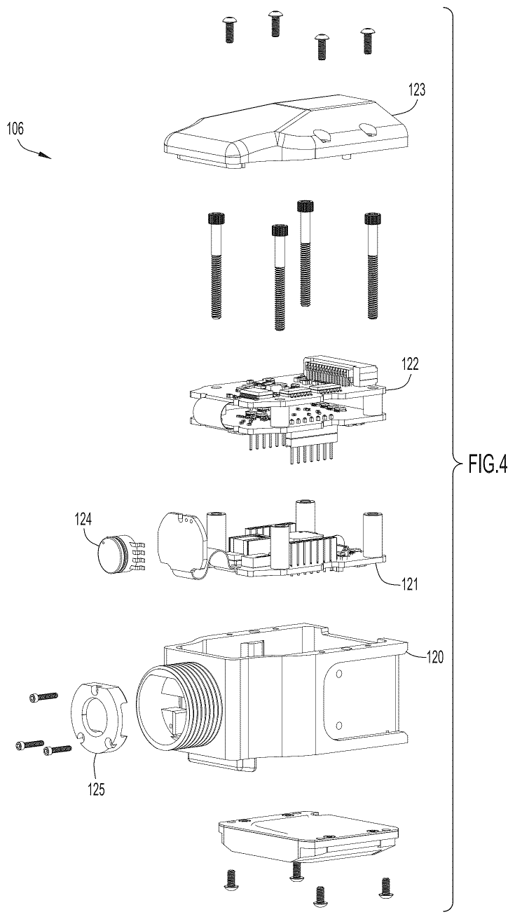

ESAD module 106 is illustrated in detail in FIG. 4 and includes a housing 120 in which is located a high voltage circuit 121 and logic circuitry 122, each disposed on respective printed wiring boards (PWB). A housing lid 123 covers the top of the housing. A low energy exploding foil initiator 124 is disposed forwardly of high voltage PWB 121 in or adjacent threaded connector 107 and is retained in place relative to PWB 121 via an annular retainer 125. It is to be understood that the ESAD module may not be activated when the payload is not a warhead.

Miniature projectiles of the type described herein typically have a length in the range of about ten to seventeen inches, with a length to width ratio between eight and fifteen, and a weight of less than a pound without the warhead. The total mass of the projectile is typically no more than two pounds, depending on the material and warhead type. It will be appreciated, therefore, that manual attachment of the warhead to and removal of the warhead from the projectile body 101 is easily manually achieved by personnel in the field without the need for tools.

In a typical operation in the field, an operator decides on the type of payload 105 to be employed for the mission; e.g., a fragmentation warhead for attacking personnel and light armored targets, a shaped charge warheads for anti-tank and other armor penetration, a kinetic warhead, a supplies delivery package, etc. To install the selected payload unit on projectile 100, the operator attaches the unit to ESAD module 106 by hand by screwing the unit onto threaded connector 107. Thereafter, the projectile is loaded onto a projectile delivery system such as an unmanned aerial vehicle which, as disclosed in the Treadway et al patent, may be designed to carry one or more such projectiles to a location from which the projectile(s) may be launched. Once the projectile delivery system is at the desired location, the operator may initiate a launch sequence in which the projectile is dispatched toward a target or target area. The launch process may be as described in the Treadway et al patent.

In some cases the projectile may be delivered to a base site or other location with a payload attached. If field personnel at the base site determine that the attached payload is not the type needed for the mission at hand, that payload may be readily removed and replaced with a payload unit designed for that mission. Thus, the system as described may be viewed as hot swappable in the sense that it includes at least two payloads designed for different respective mission functions wherein a payload unit configured for one type of function can be replaced on a projectile body with a payload unit configured for a different function by user personnel in the field, i.e., without requiring that the entire projectile be returned to a manufacturing facility. The projectile body and payload may be made from any suitable material, such as metal, molded plastic, etc. As noted above, the entire assembly is lightweight and small, making it easy for one person to effectively swap payloads on a projectile body.

In conclusion, provided for herein are techniques that provide for and facilitate interchange of payload units on miniature projectiles by untrained or minimally trained user personnel at field installations for the purpose of accommodating projectile mission requirements.

The above description is intended by way of example only. Although the techniques are illustrated and described herein as embodied in one or more specific examples, it is nevertheless not intended to be limited to the details shown, since various modifications and structural changes may be made within the scope and range of equivalents of the claims.

What is claimed is:

1. A projectile system adapted for launch from an unmanned aerial vehicle controlled from a base site, said system comprising:
a projectile body having forward and aft ends;
a first payload unit having an aft end configured for manually removable engagement at the base site with the forward end of the projectile body.

2. The projectile system of claim 1, wherein the removable engagement is a threaded engagement.

3. The projectile system of claim 2, further comprising:
a hollow generally cylindrical aft end of said payload unit;
a generally cylindrical connector projecting forward from projectile body;
wherein said threaded engagement comprises exterior threading on an exterior surface of said connector, and interior threading on an interior surface at the aft end of said payload unit, said interior threading being configured to threadedly engage said exterior threading of said connector.

4. The projectile system of claim 3, further comprising a second payload unit having a hollow generally cylindrical aft end with interior threading substantial identical to said first payload unit, wherein said first and second payload units are configured to perform different respective mission functions and be interchangeably threadedly engaged with the projectile body.

5. The projectile system of claim 4, wherein the projectile body houses:
an onboard steering system, including a steering mechanism operable to change an attitude, orientation, and/or direction of flight of the projectile system, and a steering actuator operable to control the steering mechanism; and
a radio-frequency (RF) receiver adapted to receive signals from a base station from which the projectile is controlled.

6. The projectile system of claim 5 wherein at least one of said first and second payload units is an explosive warhead.

7. The projectile system of claim 1, further comprising a second payload unit configured for manually removable engagement with the forward end of said projectile body, wherein said first and second payload units are configured to perform different respective mission functions and be interchangeable on the projectile body.

8. The projectile system of claim 7, wherein the removable engagement is a threaded engagement.

9. The projectile system of claim 8, further comprising:
hollow generally cylindrical aft ends of said first and second payload units;
a generally cylindrical connector projecting forward from projectile body;
wherein said threaded engagement comprises exterior threading on an exterior surface of said connector, and interior threading on an interior surface at the aft end of each of said first and second payload units, said interior threading being configured to threadedly engage said exterior threading of said connector.

10. The projectile system of claim 1 wherein said first payload unit is a warhead.

11. A method of replacing payloads of a projectile adapted for launch from an unmanned aerial vehicle controlled from a base site, said method comprising, at said base site, manually unscrewing a first payload unit from a threaded engagement with the forward end of the projectile body, and manually screwing a second payload unit onto the forward end of the projectile body.

12. The method of claim 10 wherein said first and second payload units are configured to perform different respective mission functions.

13. The method of claim 12 wherein at least one of said first and second payload units is an explosive warhead.

14. A method of securing a payload unit to projectile body comprising manually screwing the payload unit onto the forward end of the projectile body.

15. The method of claim 14 wherein said payload unit is an explosive warhead.
